(19) United States
(12) Patent Application Publication
(10) Pub. No.: US 2012/0088069 A1
(43) Pub. Date: Apr. 12, 2012

(54) Window-well egress with artistic surfaces

(76) Inventor: Mark Alan Wiwi, South Bend, IN (US)

(21) Appl. No.: 13/317,187

(22) Filed: Oct. 12, 2011

Related U.S. Application Data
(63) Continuation-in-part of application No. 13/068,845, filed on May 4, 2010.

(51) Int. Cl. B32B 3/00; B29C 41/04

(52) U.S. Cl. 428/141; 264/310; 264/220

(57) ABSTRACT

A rotomolded window-well egress (190) includes a textured or artistic surface on (196) a front side (193), strengthening irregularities (200, 210), in the form of ribs (200) or corrugations (210), molded on a back side (199), and means (202) for preventing the strengthening irregularities (200, 210) from printing out onto the textured or artistic surface (196).

### CROSS-REFERENCES TO RELATED APPLICATIONS

This patent application in a Continuation-in-Part of U.S. patent application No. 13/068,845, filed May 4, 2010, and priority thereto is claimed.

### STATEMENT RE FEDERALLY SPONSORED RESEARCH OR DEVELOPMENT

Not Applicable

### REFERENCE TO “SEQUENCE LISTING”

Not Applicable

### BACKGROUND OF THE INVENTION

1. Field of the Invention

The present invention relates generally to plastic panels and window-well egresses. More particularly, the present invention pertains to rotomolded panels and window-well egresses with an artistic surfaces molded on one side, and strengthening irregularities molded on an opposite side.

2. Description of the Related Art

Plastic has become an important material for making a vast array of articles in nearly every field, from toys to household goods, automobiles, home construction, highway safety, and even security barriers for public and governmental buildings. While injection molding and vacuum molding of plastics have important places, for larger plastic articles, rotomolding is the method of choice.

In rotomolding, a mold, having two halves, is commonly made from aluminum sheets, aluminum extrusions, and/or aluminum castings. The rotomold is attached to a machine that is capable of rotating the mold around both X and Y axes, and the rotomold is inserted into a furnace that heats the rotomold to the melting temperature of the selected thermoplastic.

In operation, the mold is opened, thermoplastic pellets are inserted, the mold is closed, heat is applied to the mold, and the mold is rotated about both X and Y axes until the thermoplastic is thoroughly melted, and until the inside surfaces of the rotomold are coated with the melted thermoplastic.

When the mold is opened, the molded part closely conforms to the mold in size, shape, and texture. With regard to texture, it has been common practice to sandblast or shot peen the inside of a rotomold so that the resultant texture conceals any blemish in the rotomold, conceals any blemish in the molded article, and adds to the attractiveness of the rotomolded articles.

Rotomolding is used to mold containers used for storing and/or transporting parts in manufacturing plants, for containing water or other fluids, and for containing dry materials.

With regard to plastic containers, rotomolding is useful for molding plastic barrels, that when filled with sand and placed in a row in front of a highway barricade, can provide a more moderate deceleration when hit by a car than occurs when hitting a concrete structure, thereby shielding automobile occupants from deadly crashes into highway structures.

Rotomolding is also useful for molding articles used to conceal or disguise utilitarian objects. A home owner, whose pride is his home, is not pleased to have a transformer or a gas meter dominate his lawn and shrub decor. To meet this felt need, rotomolded replicas of rocks have been made to look like natural stones to disguise or conceal these utilitarian objects.

Large rotomolded containers, filled with sand and disposed in a row, can be used to provide highway traffic separators. Perhaps even more importantly, large rotomolded containers, filled with sand, can be placed in front of public or governmental buildings to provide security from terrorist car bombers.

An important rotomolding product is window-well egresses, because they are important for fire safety. While window-well egresses have been made from poured cement, stone, brick, and corrugated steel, rotomolded plastic has been used to advantage. Van Gilst, in U.S. Pat. No. 6,713,009, which issued on Mar. 30, 2004, teaches a method in which steel ladder rungs can be rotomolded into a window-well egress.

As set forth above, rotomolding produces a plastic article that conforms to the entire interior surface of the rotomold. Containers that are rotomolded for receiving, transporting, and storing parts, must have a rotomolded portion cut off to provide an opening to the container. For some other applications, two parts are molded in tandem and separated subsequently. Portions that must be cut off of rotomolded plastic articles represent costly scrap.

Rotomolded plastic window-well egresses have been notorious for the percentage of scrap that is produced, even though designed for optimum strength/weight ratios. As is inherent to the rotomolding process, rotomolding window-well egresses produced a back wall that was not only unnecessary but also wasteful. Some of this waste was regained by returning the back wall as scrap to the plastics supplier for recycling into plastic molding pellets. But it still represented a huge waste.

In contrast, window-well egresses as taught herein achieve superior strength/cost ratios, achieve superior strength/weight ratios with regard to the quantity of plastic that is molded, and eliminate the necessity of molding panels that are redundant, that must be cut off, chipped, and used as scrap.

For those who live or work where they look at a window-well egress day after day, appearance becomes important, and rotomolding can meet this felt need. Window-well egresses, and other panel structures, can be rotomolded with a gray or blue-gray color that is very similar to various varieties of stone. The rotomold may then be shot peened to give the rotomolded egress a pleasing texture.

More importantly, as taught herein, as also taught in U.S. patent application No. 13/068,845, filed May 4, 2010, and incorporated herein by reference thereto, window-well egresses and other large panels can be rotomolded with artistic surfaces, or textured surfaces, on one side, and strengthening irregularities on an opposite side, without the strengthening irregularities printing out onto, and therefore marring the artistic renderings.

In the above-discussed applications, and numerous others not discussed herein, the present invention provides a method for rapidly and economically making rotomolds with artistic renderings, whereby nearly any artistic surfaces, or textured surface, can be rotomolded onto nearly any rotomolded article at a reasonable cost. Considering the desire of architects to beautify everything from homes to highways, to public and governmental buildings, it can be seen that the present invention is of considerable economic significance.

### BRIEF SUMMARY OF THE INVENTION

In a preferred embodiment of the present invention, a method for making a rotomold comprises creating or providing a textured surface, producing a negative of the textured surface, producing a positive from the negative; and casting an aluminum negative.

Preferably, the negative is produced by successively laying up thin layers of a curable material, such as a plastic or elastomer, onto a textured surface or artistic surface. More particularly, the preferred method comprises laying up thin layers of silicone rubber, and producing a complementary surface on an opposite side of the negative, so that the negative is substantially uniform in thickness.

Optionally, the method of making the rotomold includes selectively contouring the negative; supporting the negative in the selectively contoured shape; molding a plaster positive; and then molding a selectively contoured aluminum negative of generally constant thickness from the plaster positive.

In the preferred method, a stone mason creates an artistic rendering by laying stone in the form of a wall portion; the wall portion is disposed horizontally; a barrier wall is disposed circumferentially around the wall portion; and liquid silicone is applied to the wall portion in successive layers, with partial curing time interposed between layers, until sufficient strength is achieved for molding a plaster positive, while maintaining sufficient flexibility for selective contouring.

The method disclosed above produces remarkably pleasing, even astonishingly-attractive results. However, to rotomold large panels and window-well egresses economically, wall thickness and the quantity of plastic used must be kept to a minimum. As pointed out above, achieving the necessary strength demands that ribs, or other wall strengthening protrusions, be molded on the opposite side of the panel or egress. But changes in wall thicknesses caused by the strengthening protrusions, results in the strengthening protrusions printing out onto an otherwise stunningly attractive artistic surface or textured surface.

However, as taught in U.S. patent application No. 13/068,845, and as also taught in this Continuation-in-Part Application, a panel or window-well egress comprises: a textured surface molded onto one side of a panel; strengthening irregularities, in the form of ribs or corrugations, molded on an opposite side; and means, comprising an air space intermediate of the sides, for preventing the strengthening from printing through to the textured or artistic surface.

Further, as taught in U.S. patent application No. 13/068,845, and as taught in this Continuation-in-Part Application, a method for rotomolding a panel or window-well egress comprises: molding a textured surface, or an artistic surface, on a first side of a panel; molding strengthening irregularities, in the form of ribs or corrugations, on an opposite side of the panel; and preventing the strengthening irregularities from printing out onto the textured surface or artistic surface.

The result is not only a remarkably attractive panel or egress, but a panel or egress that has a strength/cost ratio that has been previously unattainable, and with scrap losses eliminated.

A first object of the present invention, is to produce negatives of textured and artistic surfaces;

A second object of the present invention, is to produce negatives of textured and artistic surfaces in which the negatives are substantially uniform in thickness irrespective of the textured surfaces or artistic surfaces;

A third object of the present invention, is to produce negatives of textured or artistic surfaces; produce complementary surfaces; selectively curve the negatives; and mold aluminum negatives of substantially constant thicknesses.

A fourth object of the present invention is to mold articles with a textured or artistic surface on one side;

A fifth object of the present invention is to rotomold containers for wet and dry materials, articles for concealing unsightly utilitarian articles that detract from attractive landscaping, planters for general flower and shrub planting, pillars for estate entry lamps, and planters for use as flagpole bases, all with textured or artistic surfaces;

A sixth object of the present invention is to rotomold highway safety or crash barriers and terrorist crash barriers for public and governmental buildings with textured or artistic surfaces.

A seventh object of the present invention is to rotomold panels with textured or artistic surfaces on one side, mold strengthening irregularities on an opposite side, and prevent the strengthening irregularities from printing through to the textured or artistic surfaces;

An eighth object of the present invention is to rotomold window-well egresses with a textured or artistic surface on one side, strengthening irregularities on an opposite side, and achieve a superior strength/cost ratio;

A ninth object of the present invention is to rotomold window-well egresses with a textured or artistic surface on one side, mold strengthening irregularities on an opposite side, achieve a superior strength/cost ratio, reduce the weight and cost of plastic used, reduce labor cost, and eliminate scrap;

A tenth object of the present invention is to rotomold window-well egresses with a textured or artistic surface on one side, strengthening irregularities on an opposite side, prevent the strengthening irregularities from printing out on the textured or artistic surface, achieve a superior strength/cost ratio, reduce the weight and cost of plastic used, reduce the labor cost, and eliminate scrap.

In a first aspect of the present invention, a method for rotomolding plastic panels comprises: molding a textured surface on a first side of a panel; forming strengthening irregularities on an opposite side of the panel; and preventing the strengthening irregularities from printing out onto the textured surface.

In a second aspect of the present invention, a rotomolded plastic panel comprises: a textured surface molded onto one side of the panel; strengthening irregularities molded on an opposite side; and means, comprising an air space intermediate of the sides, for preventing the strengthening from printing through to the textured surface.

In a third aspect of the present invention, a method for making a rotomold comprises: providing a surface with a textured surface; producing a negative of the textured surface; making a positive from the negative; casting a rotomold negative from the positive; and incorporating the rotomold negative into a rotomold.

### BRIEF DESCRIPTION OF THE SEVERAL VIEWS OF THE DRAWINGS

FIG. 1 is a cross-sectional elevation showing a pressure plate pressing downward onto a pressure pad, thereby deforming a curable mat down onto masonry textured surface, thereby deforming the curable mat into a flexible negative that is of generally uniform thickness, and that subsequently cures into a cured flexible negative of the masonry textured surface;

FIG. 2 is a cross-sectional elevation, taken substantially the same as FIG. 1, showing that the cured flexible negative of FIG. 1 is of substantially constant thickness;

FIG. 3 is a cross-sectional elevation, taken substantially the same as FIGS. 1 and 2, showing the cured flexible negative concavely curved by a form board, and a convex plaster positive cast into the concavely curved negative;

FIG. 4 is a cross-sectional elevation, taken substantially the same as FIGS. 1-3, showing the flexible negative of FIG. 2 concavely curved around the form board of FIG. 3, and a concave plaster mold formed against the aforesaid opposite side;

FIG. 5 is a cross-sectional elevation, taken substantially the same as FIGS. 1-4, showing a curved aluminum negative molded between the convex plaster positive of FIG. 3 and the concave plaster mold of FIG. 4;

FIG. 6 is a cross-sectional elevation, taken substantially the same as FIGS. 1-5, showing the curved aluminum negative with its substantially uniform thickness;

FIG. 7 is a perspective elevation, showing a rectangular, or circumferentially disposed, textured surface, or artistic surface, developed by a stone structure laid up by a stone mason, a curable mat disposed circumferentially thereabout, a pressure pad disposed circumferentially over the curable mat, four pressure plates (one shown) disposed over the pressure pad, and a circumferential tightening belt disposed around the four pressure plates;

FIG. 8 is a perspective view of a textured surface, or artistic surface, provided by artistically-arranged rocks in a box, illustrating a preferred method for making flexible negatives of textured surfaces or artistic surfaces;

FIG. 9 is a partial cross-section of the textured surface or artistic surface of FIG. 8, taken substantially as shown by Section Line 9-9 of FIG. 8, magnified to illustrate the textured surface, or artistic surface, and showing both the layer construction of the flexible negative and the resultant complementary image;

FIG. 10 is a partial cross-section, taken substantially horizontally, through a vertically disposed window-well egress of prior art design, rotomolded with strengthening irregularities on the back of a front wall, rotomolded integrally with a back wall that subsequently was cut off and used for scrap, showing the back wall severed from the window-well egress;

FIG. 11 is a partial cross-section of a prior art window-well egress, taken substantially the same as FIG. 10, but greatly enlarged, illustrating marring of a textured surface, or artistic surface, by strengthening irregularities, such as ribs, printing out onto the textured surface or artistic surface;

FIG. 12 is a partial cross-section of a panel or egress, taken substantially the same as FIGS. 10 and 11 illustrating how irregularities, in the form of ribs, on an opposite side, are prevented from printing out onto a textured surface, or artistic surface, by inclusion of an air space intermediate of the ribs and the textured surface, or artistic surface;

FIG. 13 is a partial cross-section of a panel or egress, taken substantially the same as FIGS. 10-12, illustrating how irregularities, such as corrugations, on an opposite surface, are prevented from printing out onto a textured surface, or artistic surface, on a first side by inclusion of an air space intermediate of the corrugations and the artistic rendering;

FIG. 14 is a perspective elevation of a window-well egress that includes a brick texture made by a method of the present invention, taken somewhat from above and somewhat to one side;

FIG. 15 is a perspective elevation of the window-well egress of FIG. 14, also taken somewhat from above, again showing some of the inner wall brick texture, but primarily showing a side and rear thereof with bracing of the outer wall; and

FIG. 16 is a partial cross-section of the window-well egress of FIGS. 14 and 15, taken substantially as shown by cross-section line 16-16.

### DETAILED DESCRIPTION OF THE INVENTION

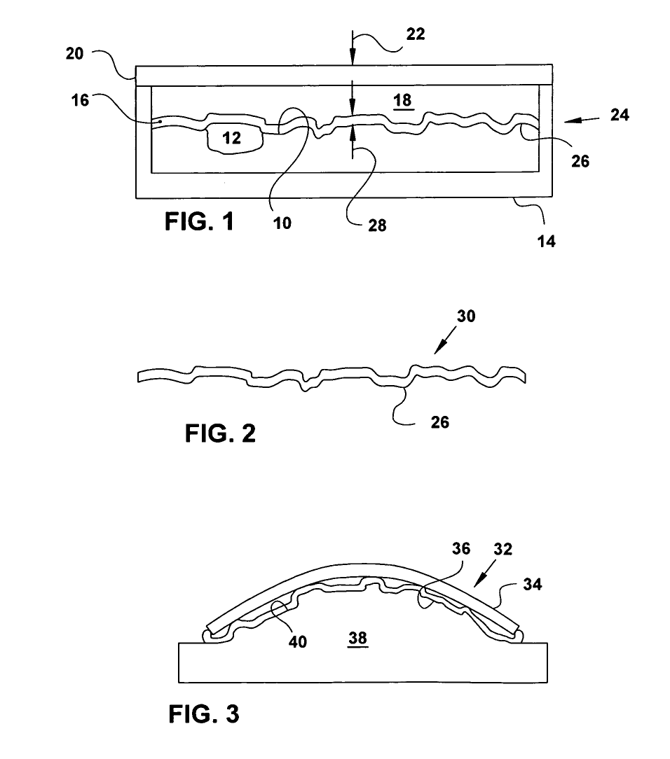

Referring now to FIG. 1, a textured surface or artistic surface 10 is created by arranging stones, or masonry, 12 in a masonry box 14. A curable plastic mat 16 is placed over the textured surface or artistic surface 10, a resilient pressure pad 18 is disposed over the curable plastic mat 16, and a rigid pressure plate 20 is disposed over the resilient pressure pad 18.

A force 22 forces the pressure plate 20 downward, pressing the resilient pressure pad 18 against the curable plastic mat 16, thereby transforming the curable plastic mat 16 into a flexible negative 24 of the textured surface or artistic surface 10 that is of generally uniform thickness 28.

Referring now to FIGS. 1 and 2, while retaining the force 22 on the pressure pad 18 and the plastic mat 16, as shown in FIG. 1, the curable plastic mat 16 self-cures into a cured flexible negative 30 with the negative textured surface or negative artistic surface 26, as shown in FIG. 2.

Referring now to FIG. 3, the cured flexible negative 30 of FIG. 2 is curved into a concave curved negative 32 of FIG. 3 by means of a curving board 34, so that the concave curved negative 32 includes a concave negative rendering 36. A convex plaster positive 38 is cast into the concave negative 32, so that the convex plaster positive 38 includes a convex curved positive rendering 40 that corresponds to the textured surface or artistic surface 10 of FIG. 1.

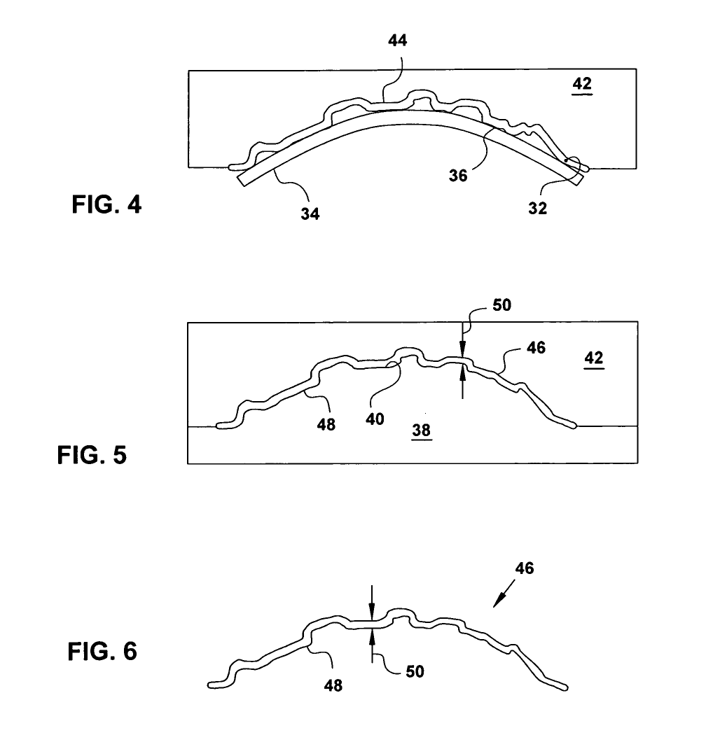

Referring now to FIG. 4, the curving and molding process is repeated, again using the curving board 34, but this time a plaster mold 42 is formed from a side 44 of the concave cured negative 32 that is opposite to, and spaced apart from, the concave negative texture, or concave negative surface, 36.

As shown in FIG. 5, the plaster mold 42 of FIG. 4 is juxtaposed on top of the plaster positive 38 of FIG. 3, and an aluminum negative 46 is cast there between. The aluminum negative 46, of FIGS. 5 and 6, includes a concave negative 48 that negatively corresponds to the convex positive 40 of the plaster positive 38, and a thickness 50 that corresponds to the thickness 28 of FIG. 1. Thus the aluminum negative 46, with its uniform thickness, is readily adaptable to use in a rotomold.

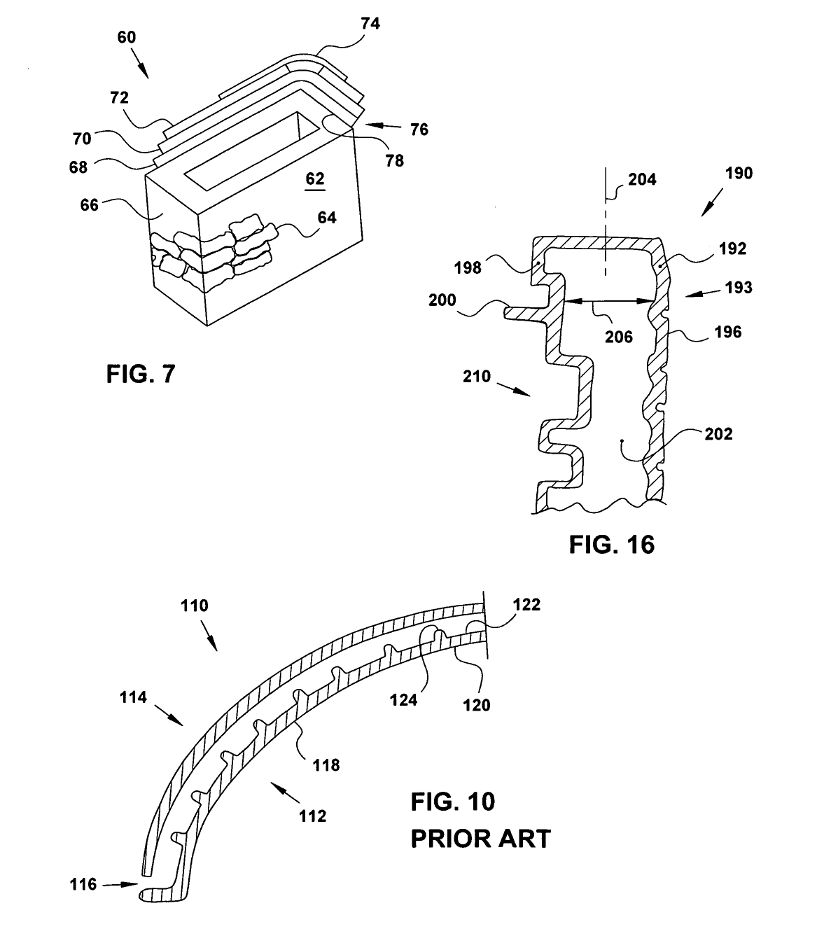

Referring now to FIG. 7, a rectangular masonry structure 60 includes sides 62 made of stones, or masonry 64, thereby providing a continuous textured surface, or artistic surface, 66 that is disposed circumferentially around the rectangular masonry structure 60. A curable mat 68 is disposed circumferentially around the masonry structure 60, a pressure pad 70 is disposed circumferentially over the curable mat 68, and four pressure boards 72 (two shown) are disposed over respective ones of the sides 62, and a circumferential belt 74 is disposed over the boards 72.

Tightening the circumferential belt 74 results in the four pressure boards 72 being pressed inwardly against the circumferential pressure pad 70 which, in turn, results in the curable mat 68 being pressed inwardly against the continuous textured surface, or artistic surface, 66, so that a circumferential, or four sided, negative 76 is formed that, when cured, provides four circumferentially continuous negative textured surfaces, or artistic surfaces, 78.

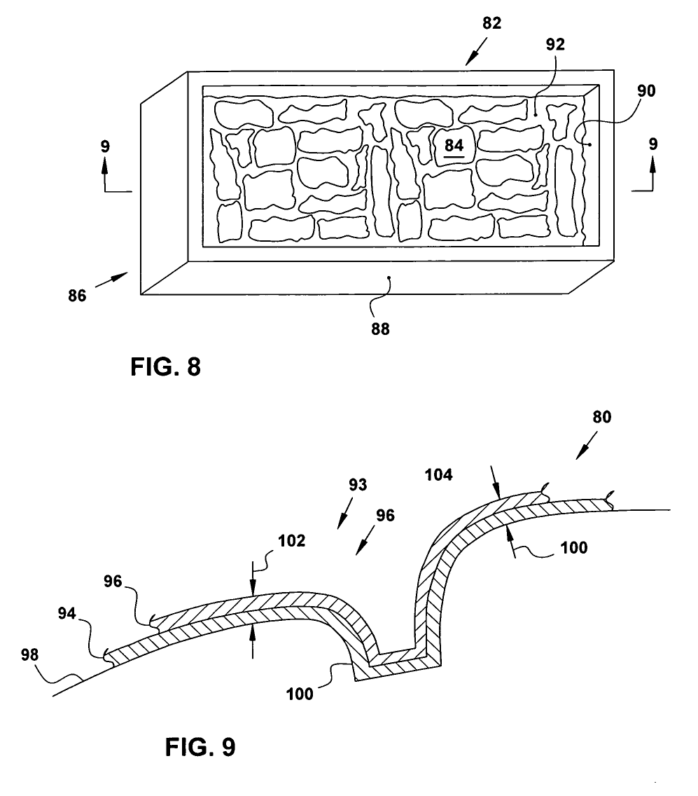

Referring now to FIG. 8, in a preferred method of making flexible negatives 80 (FIG. 9) of textured surfaces, or artistic surfaces, 82, rocks 84 are arranged artistically in a box 86. The box 86 has sides 88 that extend upward from the rocks 84 to provide a circumferential fluid-retaining barrier 90. Subsequently, the rocks 84 are grouted with any suitable grout 92 to complete the textured surface, or artistic surface, 82.

Referring now to FIG. 9, a curable plastic, curable elastomer, or curable material 93 is applied repeatedly in thin layers, as illustrated by layers 94 and 96 deposited over surfaces 98 of the rocks 84 and grout 92 (FIG. 8) to form the flexible negative 80.

The flexible negative 80 includes a negative surface 100 that almost perfectly reproduces the textured surface, or artistic surface, 98 provided by the rocks 84 and the grout 92, has a thickness 102 that is substantially constant, and includes a complementary surface 104 that reflects the process of repeatedly depositing thin layers of the curable material 93.

In the preferred process, the curable material 93 is a brush-on silicone rubber sold under the trade name “Rebound 25”. Equal quantities, by volume, of parts “A” & “B” are mixed at 73 degrees F. (23 degrees C.) for 3 to 5 minutes. Then, a thin layer, or first layer 94, is brushed onto the surface 98 (FIG. 9) of the rocks 84 and grout 92 (FIG. 8), working it carefully to form a faithful reproduction of the textured surface or artistic surface 82 of FIG. 8.

The first layer 94 is allowed to cure for at least 60 minutes, or until the first layer 94 is tacky. This process is repeated, as illustrated by a second layer 96, until four layers are applied, and until the total thickness of the flexible negative 80 is between 0.25 inches (6.4 mm) and 0.375 inches (9.4 mm) thick. Then the flexible negative 80 is allowed to cure at least 6 hours at 73 degrees F. (23 degrees C.) before incorporating it into a wood mold and subsequently molding a plaster positive.

Referring again to FIG. 7, optionally, instead of using the curable mat 68, as described above, any suitable plastic, rubber, or elastomer may be applied circumferentially around, and onto, the continuous textured surface or artistic surface 66 to form the four sided, negative 76 with the circumferentially continuous negative textured surface or artistic surface 78, generally as described in conjunction with FIGS. 8 and 9.

As illustrated in conjunction with FIG. 7, the preferred process of FIGS. 8 and 9 may be varied and adapted as needed. That is, the preferred method includes any suitable plastic, rubber, or elastomer, applied by spraying or brushing, or even pouring. However, pouring sacrifices the advantages of making a negative that is of a substantially constant thickness.

While no sealer or releasing compound is needed when using Release 25, Reynolds Advanced Materials, at www.reynoldsam.com, provides technical information regarding the physical and chemical properties of various curable materials: which ones need sealers and releasing compounds, the names of suitable sealers and releasing compounds, and how to use them.

As described herein, the preferred process of the present invention includes producing a flexible negative of a textured surface, or artistic surface, that includes both a substantially uniform thickness and a complementary image on an opposite side of the flexible negative. Although a flexible negative has the advantage of producing a rotomold with a curved reproduction of the textured surface or artistic surface, the present invention may be adapted to produce rigid negatives.

Whether the flexible negative is left flat or curved, plaster is molded onto both sides of the flexible negative to produce a plaster positive. The plaster positive includes a cavity of constant depth whose sides reproduce both the positive of the original textured surface, or artistic surface, and the complementary image. Subsequently, an aluminum negative is molded in the plaster mold. The aluminum negative includes a negative of the textured surface, or artistic surface, and a constant thickness.

As adapted into a rotomold, one advantage of an aluminum negative with a uniform thickness is: uniformity of wall thickness of the rotomold results in uniform melting of the plastic pellets, and therefore results in uniform wall thickness of the article being rotomolded. Since a certain minimum thickness of the walls of the plastic article is necessary for strength, any localized increase in wall thickness of the plastic represents additional material cost.

A second advantage of an aluminum negative of uniform thickness, when adapted into a rotomold, is that different rotomolds, for molding different articles, and/or for different customers, can be rotomolded in the same furnace at the same time, because the cycle time will be the same.

Referring now to FIG. 10, a portion of rotomolded structure 110 of prior art design, is shown as a horizontally-disposed cross-section. The rotomolded structure 110 includes both a prior art window-well egress 112 and a scrap back wall 114. As known by those skilled in the art, inclusion of the back wall 114 is inherent to the rotomolding process. Subsequent to rotomolding, the back wall 114 is severed from the window-well egress 112, as shown by a cut 116.

The window-well egress 112 includes a wall 118 with a first or front side 120, and an opposite side or back side 122. Strengthening irregularities, in the form of ribs 124 are molded onto the back side 122.

In this prior art design, subsequent to severing the back wall 114 from the window-well egress 112, the back wall 114 is cut into smaller parts and chipped for recycling. As clearly understood by viewing FIG. 10, a high percentage of the rotomolded plastic, which was prime plastic, and which was carefully blended for color, is reduced to scrap. It is reduced in value to approximately one-fourth of its original cost.

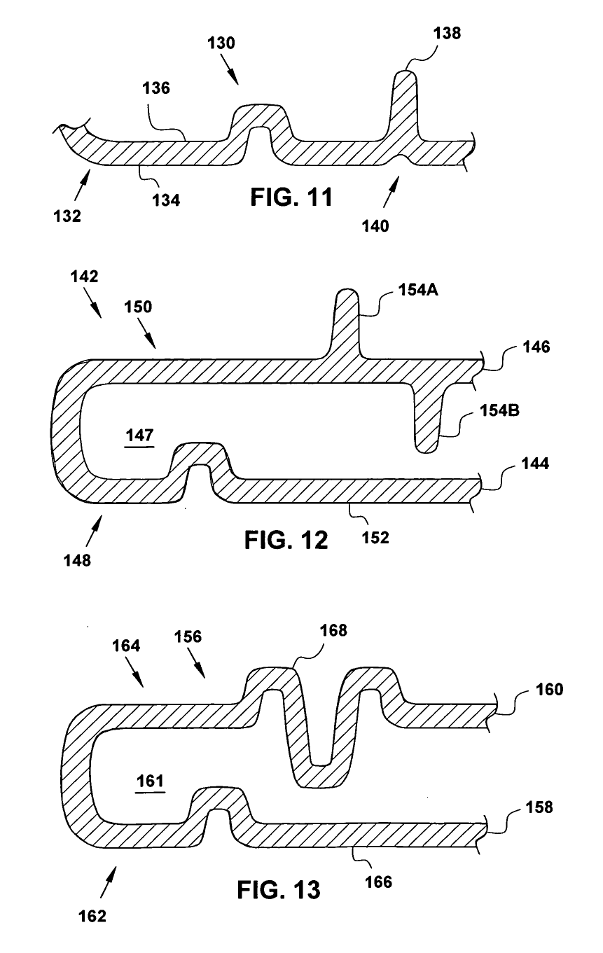

Referring now to FIG. 11, a portion of rotomolded panel, or window-well egress 130 is shown as a horizontally-disposed cross-section. The panel or egress 130 includes a first side or front side, 132, with a textured surface, or artistic surface, 134, an opposite side or back side, 136, and a strengthening irregularity, or rib, 138, molded on the back side 136.

As illustrated in FIG. 11, the textured surface or artistic surface 134 is marred by a shrinkage depression 140. Inherently, shrinkage will cause marring of a surface opposite to a change in cross section, such as the rib 138. While of little important for most rotomolded articles, with a textured surface, or artistic surface 134 molded onto one side of a panel or egress, marring becomes a critical factor.

Referring now to FIG. 12, a portion of rotomolded panel, or window-well egress, 142 is shown as a horizontally-disposed cross-section. The panel or window-well egress 142 includes a first wall or front wall 144, and an opposite wall or back wall 146 that are separated by an air space 147.

The front wall 144 includes a first side or front side 148; and the back wall 146 includes an opposite side or back side 150. The front wall 144 includes a textured surface or artistic surface 152 on the front side 148, and the back wall 146 includes ribs, or strengthening irregularities 154A and 154B. As shown, the rib 154A extends outwardly from the back wall 146, and the rib 154B extends inwardly from the back wall 146.

The air space 147 prevents either of the ribs, 154A or 154B, from printing out onto the textured surface, or artistic surface, 152. Stated another way, the air space 147, which is disposed between the front side 148 and the back side 152 prevents the ribs, 154A or 154B, from printing out onto the textured surface, or artistic surface, 152. As shown, the air space 147 divides the panel or window-well egress 142 into two walls, as previously named: a front wall 144 and a back wall 146.

Stated still another way, since the air space 147, divides the panel or window-well egress 142 into the front wall 144 and the back wall 146, and since the textured surface, or artistic surface, 152 is disposed on the front wall 144 and the ribs, 154A and 154B are disposed on the back wall 146, the air space 147 prevents either of the ribs, 154A or 154B, from printing out on the textured surface or artistic surface 152.

Referring now to FIG. 13, a portion of rotomolded panel, or window-well egress 156 is shown as a horizontally-disposed cross-section. The panel or window-well egress 156 includes a first wall or front wall 158, and an opposite wall or back wall 160 that are separated by an air space 161.

The front wall 158 includes a first side or front side 162; and the back wall 160 includes an opposite side or back side 164. The front wall 158 includes a textured surface, or artistic surface, 166 on the front side 162, and the back wall 164 includes corrugations, or strengthening irregularities, 168. As shown, and optionally, the corrugations 168 extend both outwardly and inwardly from the back wall 160.

The air space 161 prevents the corrugations 168 from printing out onto the textured surface, or artistic surface, 166. Stated another way, the air space 161, which is disposed between the front side 162 and the back side 164 prevents the corrugations 168 from printing out onto the textured surface, or artistic surface, 166. As shown, the air space 161 divides the panel or window-well egress 156 into two walls, as previously named: a front wall 158 and a back wall 160.

Stated still another way, since the air space 161, divides the panel or window-well egress 156 into the front wall 158 and the back wall 160, and since the textured surface, or artistic surface, 166 is disposed on the front wall 158 and the corrugations 168 are disposed on the back wall 160, the air space 161 prevents the corrugations 168 from printing out on the textured surface or artistic surface 166.

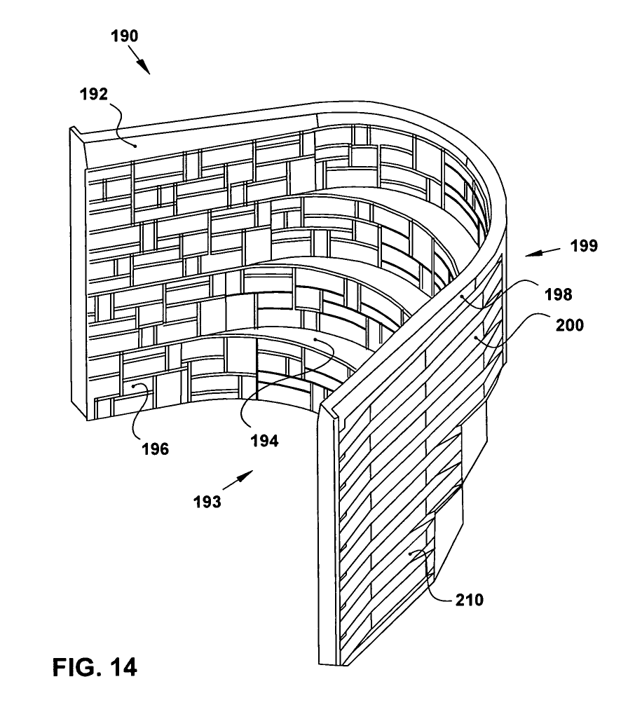

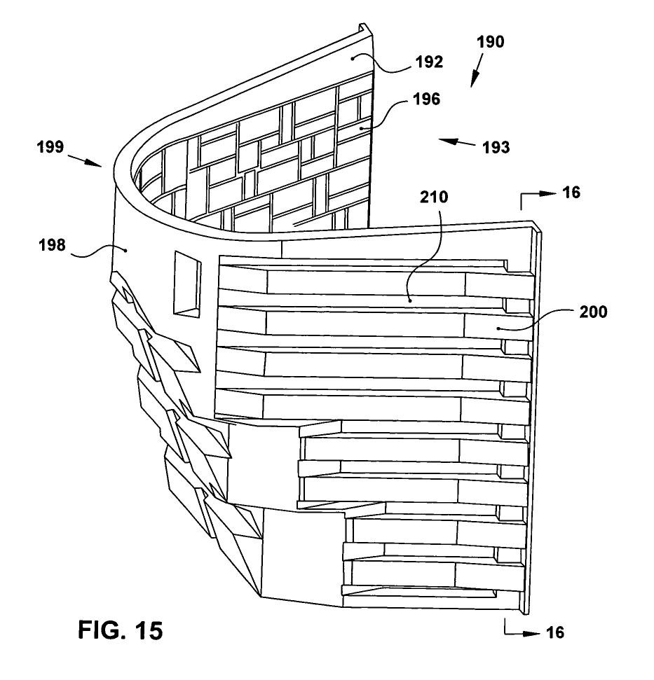

Referring now to FIGS. 14-16, a window-well egress 190 includes a front wall, or inner wall 192 that includes a front side, or inside 193, steps 194 (shown only in FIG. 14) on the front side 193, a textured surface, or artistic surface, 196 on the front side, 193, and a back wall, or outer wall 198, with ribs, or strengthening irregularities 200 on a back side 199.

In addition to providing a method for molding the window-well egress 190 with a textured surface, or artistic surface, such as the artistic surface 196, and preventing strengthening irregularities, such as the ribs 200, from marring the textured surface, or artistic surface, 196, the present invention achieves greater strength/cost ratios than previous rotomolded window-well egresses.

More particularly, the egress 190 of the present invention achieves greater strength by virtue of the inner wall 192 and outer wall 198 being separated by an air space 202 as shown in FIG. 16. Because the air space 202 spreads the walls 192 and 198, the moment of inertia about any axis in a plane 204 of FIG. 16 is increased approximately as a function of the cube of a distance 206 between the inner wall 192 and the outer wall 198.

In addition, greater strength is achieved by molding ribs 200 on the outer wall 198 that are larger than could be molded onto the rear of a single-wall egress without an image of the ribs 200 printing through the inner wall 192, and thereby marring the textured surface or artistic surface 196 of FIGS. 14-16.

Because of the air space 202 that separates the inner wall 192 from the outer wall 198, instead of forming the ribs 200, it is possible to form corrugations 210 that depend into the air space 202 and extend outwardly from the outer wall 198, so that the corrugations 210 help to achieve a strength/cost ratio that would be impossible to achieve by use of conventional ribs or even the ribs 200.

Because both walls, 192 and 198 of FIG. 16 are used to provide strength, and because of the aforesaid increase in the moment of inertia about any axis in the plane 204 of FIG. 16, the thickness of the walls 192 and 198 of FIG. 16 can be reduced, and the resultant strength/cost of plastic ratio is increased. More particularly, with the distance 206 in a preferred range of 4.5 inches (11.5 cm.) to 5.0 inches (12.7 cm.), the ratio of strength to cost of plastic is approximately doubled.

In summary, the present invention provides a method for both rapidly and economically making rotomolds with nearly any desired textured surface, or artistic surface, that articles that otherwise are visually boring, if not visually offensive, become artistically pleasing.

Further, as discussed above, rotomolded articles with artistic surfaces made by the method of the present invention, range from utilitarian articles, to articles that cover unsightly articles, to articles that enhance fire safety, as in the window-well egress of the present invention, to articles that enhance highway safety by providing crash barriers, and to articles that provide protection from terrorist bombers around public and governmental buildings.

Finally, the present invention provides a method for rotomolding articles with an improved strength-cost ratio in addition to providing a method for making rotomolds with nearly any desired artistic surfaces.

As defined herein, a textured surface includes any surface in which surface irregularities are intentionally included in an original positive, in a negative, whether flexible or rigid, in a plaster mold, in an aluminum mold, and/or in a rotomolded part.

Further, as defined herein, a textured surface includes not only surfaces that are textured by shot-peening, and other randomly made surface irregularities, but also artistic surfaces. An artistic surface is a textured surface in that it includes surface irregularities, but a textured surface is not necessarily an artistic surface.

While specific apparatus and method have been disclosed in the preceding description, it should be understood that these specifics have been given for the purpose of disclosing the principles of the present invention, and that many variations thereof will become apparent to those who are versed in the art.

What is claimed is:

1. A method for rotomolding plastic panels which comprises:
a) molding a textured surface on a first side of a panel;
b) forming strengthening irregularities on an opposite side of said panel; and
c) preventing said strengthening irregularities from printing out onto said textured surface.

2. The method claimed in claim 1 in which said preventing step comprises disposing an air space between said first and opposite sides.

3. The method claimed in claim 1 in which said step of forming strengthening irregularities comprises molding ribs.

4. The method claimed in claim 1 in which said preventing step comprises dividing said panel into first and opposite walls.

5. The method claimed in claim 1 in which said step of forming strengthening irregularities comprises molding corrugations.

6. The method claimed in claim 1 in which:
a) said method further comprises defining an egress passageway on said first side;
b) said defining step comprises concavely contouring said first side; and
c) said preventing step comprises disposing an air space between said first and opposite sides.

7. The method claimed in claim 1 in which:
a) said method comprises defining an egress passageway on said first side;
b) said defining step comprises concavely contouring said first side;
c) said method further comprises molding egress steps integral with said concavely contoured first side; and
d) said preventing step comprises dividing said panel into first and opposite walls.

8. A rotomolded plastic panel which comprises:
A textured surface molded on one side of said panel;
strengthening irregularities on an opposite side; and
means, comprising an air space intermediate of said sides, for preventing said strengthening irregularities from printing through to said textured surface.

9. The rotomolded plastic structure claimed in claim 8 in which said strengthening irregularities comprise ribs.

10. he rotomolded plastic structure claimed in claim 8 in which said structure includes means, comprising a concave shape of one of said sides, for defining an egress passageway.

11. The rotomolded plastic structure claimed in claim 8 in which:
said structure comprises means for defining an egress passageway; and
said structure further comprises rotomolded steps in said passageway.

12. A method for making a rotomold which comprises:
a) providing a textured surface;
b) producing a negative of said textured surface;
c) making a positive from said negative;
d) casting a rotomold negative from said positive; and
e) incorporating said rotomold negative into a rotomold.

13. The method claimed in claim 12 in which said step of producing said negative comprises:
a) applying curable material to said textured surface; and
b) maintaining a thickness of said curable material substantially constant.

14. The method claimed in claim 12 in which step of producing said negative comprises:
a) applying curable material to said textured surface; and
b) producing a complementary image on an opposite side of said negative.

15. The method claimed in claim 12 in which producing step comprises:
a) repeatedly applying thin layers of curable material to said textured surface; and
b) allowing partial curing intermediate of said applying steps.

16. The method claimed in claim 14 in which producing step comprises:
a) repeatedly applying thin layers of curable material to said textured surface; and
b) allowing partial curing intermediate of said applying steps; and
c) maintaining a thickness of said plastic substantially constant.

17. The method claimed in claim 12 in which:
a) said method further comprises contouring said negative; and
b) said casting step comprises casting a contoured negative with a substantially uniform thickness.

18. The method claimed in claim 12 in which:
a) said step of producing said negative comprises repeatedly applying thin layers of curable material to said textured surface;
b) said producing step further comprises producing a complementary image on an opposite side of said negative;
c) said method further comprises contouring said negative; and
d) said casting step comprises casting a contoured negative with a substantially uniform thickness.

19. The method claimed in claim 12 in which said step of producing said negative comprises conforming a resilient sheet to said textured surface.

20. The method claimed in claim 12 in which:
a) said step of providing a textured surface comprises providing a circumferential textured surface;
b) said method further comprises disposing said circumferential textured surface vertically; and
c) said step of producing a negative comprises repeatedly disposing thin layers of curable material circumferentially around said textured surface.
